(19) United States
(12) Patent Application Publication
(10) Pub. No.: US 2020/0104383 A1
(43) Pub. Date: Apr. 2, 2020

(54) USING A/B TESTING TO SAFELY TERMINATE UNUSED EXPERIMENTS

(71) Applicant: Microsoft Technology Licensing, LLC, Redmond, WA (US)

(72) Inventors: Alexander Ivaniuk, Sunnyvale, CA (US); Jingbang Liu, Cupertino, CA (US); Ruirui Xiang, Mountain View, CA (US)

(73) Assignee: Microsoft Technology Licensing, LLC, Redmond, WA (US)

(21) Appl. No.: 16/146,662

(22) Filed: Sep. 28, 2018

(51) Int. Cl. G06F 17/30; G06F 9/48; G06Q 30/02; G06F 11/30

(52) U.S. Cl. CPC G06F 17/30117; G06F 9/4812; G06F 17/30469; G06F 11/3072; G06F 17/30489; G06Q 30/0201; G06F 17/30864

(57) ABSTRACT

The disclosed embodiments provide a system that uses A/B testing to safely terminate unused experiments. During operation, the system determines a first A/B test that matches one or more criteria for removal from an A/B testing platform. Next, the system initiates a first ramp-down of the first A/B test to observe an effect of a control variant on a performance metric for the first A/B test. When the effect includes a change in the performance metric, the system automatically removes code blocks that use the first A/B test on the A/B testing platform and terminates the first A/B test.

### BACKGROUND

### Field

The disclosed embodiments relate to A/B testing. More specifically, the disclosed embodiments relate to techniques for using A/B tests to safely terminate unused experiments.

### Related Art

A/B testing, or controlled experimentation, is a standard way to evaluate user engagement or satisfaction with a new service, feature, or product. For example, a company may use an A/B test to show two versions of a web page, email, article, social media post, layout, design, and/or other information or content to users to determine if one version has a higher conversion rate than the other. If results from the A/B test show that a new treatment version performs better than an old control version by a certain amount, the test results may be considered statistically significant, and the new version may be used in subsequent communications or interactions with users already exposed to the treatment version and/or additional users.

Most A/B tests undergo a manual “ramp up” process, in which exposure to a treatment version is restricted to a small percentage of users and gradually increased as metrics related to the performance of the treatment version are collected. Such ramping up may be performed to control risks associated with launching new features, such as negative user experiences and/or revenue loss.

On the other hand, an experiment that is fully ramped to 100% exposure to the treatment version can be forgotten by the owner of the experiment and left running on an A/B testing platform. As a result, the experiment may consume computational and/or storage resources associated with the A/B testing platform long after the experiment is used to assess the performance of the treatment and control versions and make decisions regarding subsequent ramping and/or use of the treatment version.

### BRIEF DESCRIPTION OF THE FIGURES

FIG. 1 shows a schematic of a system in accordance with the disclosed embodiments.

FIG. 2 shows a system for using A/B testing to safely terminate an unused experiment in accordance with the disclosed embodiments.

FIG. 3 shows a flowchart illustrating a process of using A/B testing to safely terminate an unused experiment in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing A/B testing. During an A/B test, one set of users may be assigned to a treatment group that is exposed to a treatment variant, and another set of users may be assigned to a control group that is exposed to a control variant. The users' responses to the exposed variants may then be monitored and used to determine if the treatment variant performs better than the control variant.

More specifically, the disclosed embodiments provide a method, apparatus, and system for using A/B testing to safely terminate unused experiments. An unused experiment may include an A/B test that has been fully ramped to 100% on an A/B testing platform for a sustained period (e.g., a number of weeks or months) and/or an A/B test that has been running on the A/B testing platform without affecting user experiences and/or performance metrics. The unused experiments may be identified based on the fully ramped status, the period over which the experiments have been running and/or fully ramped, user input, and/or other criteria.

Once an A/B test is identified as a candidate for removal from the A/B testing platform, a ramp-down of the A/B test is initiated to observe an effect of the treatment variant on a performance metric for the A/B test. If the ramp-down has no effect on the performance metric, the A/B test may be identified to be no longer used to effect user experiences, and the ramp-down is continued. Once the ramp-down is fully complete, the A/B test can be terminated to free up computational and/or storage resources in the A/B testing platform.

If the ramp-down changes the performance metric, the A/B test may be identified as being used by code that selects the treatment or control variant for exposure to users. As a result, code blocks that use the A/B test may be removed before terminating the A/B test to ensure that the treatment variant continues to be presented to users after the A/B test is discontinued.

By using A/B testing techniques to characterize experiments that are no longer used to collect performance metrics and/or make decisions related to the corresponding treatment and control variants, the disclosed embodiments may allow for automatic safe removal of the experiments even when the experiments are used by external code blocks to expose users to the treatment variants. In turn, removal of selected experiments may decrease computational and/or storage resources consumed by the experiments without adversely impacting the use of treatment variants that were tested using the experiments. Consequently, the disclosed embodiments may improve the performance of computer systems and/or technologies for performing A/B testing and/or reclaiming computational and/or storage resources.

### Using A/B Testing to Safely Terminate Unused Experiments

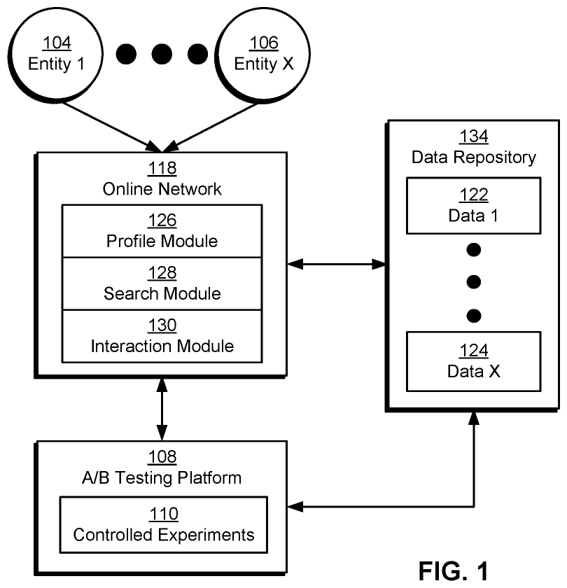

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In turn, data in data repository 134 may be used by an A/B testing platform 108 to conducted controlled experiments 110 of features in online network 118. Controlled experiments 110 may include A/B tests that expose a subset of the entities to a treatment version of a message, feature, and/or content. For example, A/B testing platform 108 may select a random percentage of users for exposure to a new treatment version of an email, social media post, feature, offer, user flow, article, advertisement, layout, design, and/or other content during an A/B test. Other users in online network 118 may be exposed to an older control version of the content.

During an A/B test, entities affected by the A/B test may be exposed to the treatment or control versions, and the entities' responses to or interactions with the exposed versions may be monitored. For example, entities in the treatment group may be shown the treatment version of a feature after logging into online network 118, and entities in the control group may be shown the control version of the feature after logging into online network 118. Responses to the control or treatment versions may be collected as clicks, views, searches, user sessions, conversions, purchases, comments, new connections, likes, shares, and/or other performance metrics representing implicit or explicit feedback from the entities. The metrics may be aggregated into data repository 134 and/or another data-storage mechanism on a real-time or near-real-time basis and used by A/B testing platform 108 to compare the performance of the treatment and control versions.

A/B testing platform 108 may also use the assessed performance of the treatment and control versions to guide ramping up of the A/B test. During such ramping up, exposure to the treatment version may be gradually increased as long as the collected metrics indicate that the treatment version is performing well, relative to the control version. Ramping up may continue until the treatment version is exposed to 100% of users and/or entities in online network 118.

On the other hand, A/B testing platform 108 may include a number of long-running controlled experiments 110 that are no longer used to compare the performance of the corresponding treatment and control versions and/or make decisions related to selecting the treatment or control versions for subsequent exposure to users. For example, some controlled experiments 110 may continue executing on A/B testing platform 108 for sustained periods (e.g., weeks or months) after treatment versions in the experiments have been fully ramped to 100% of users. In turn, such experiments may consume computational and/or storage resources on A/B testing platform 108 without utilizing the functionality of and/or deriving value from A/B testing platform 108.

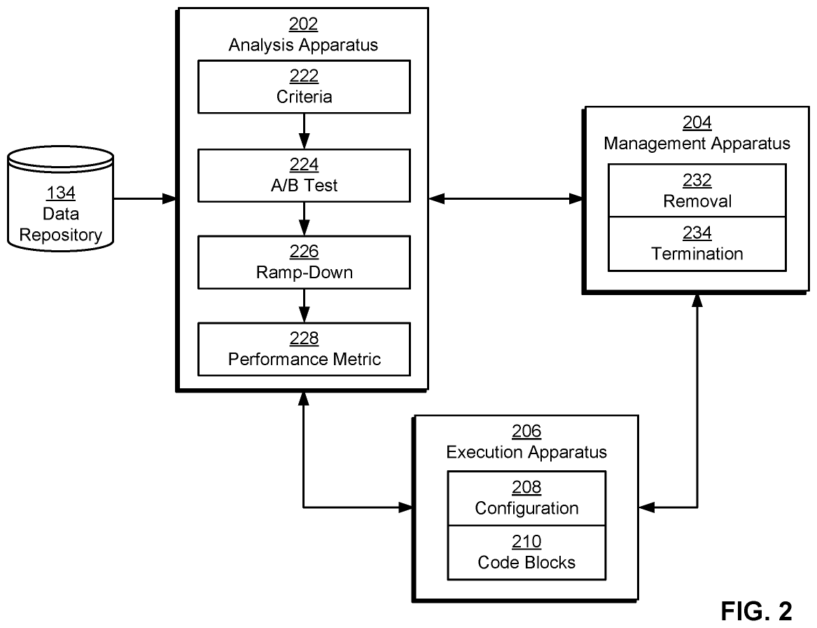

In one or more embodiments, A/B testing platform 108 uses built-in A/B testing functionality to automatically detect and/or terminate unused controlled experiments 110. As shown in FIG. 2, a system for using A/B testing to safely terminate an unused experiment (e.g., A/B testing platform 108 of FIG. 1) includes an analysis apparatus 202, a management apparatus 204, and an execution apparatus 206. Each of these components is described in further detail below.

Execution apparatus 206 manages the execution of an A/B test 224 in the A/B testing platform. First, execution apparatus 206 uses a configuration 208 for A/B test 224 to set up A/B test 224 in the A/B testing platform. Configuration 208 may be obtained from a user setting up A/B test 224 (e.g., an owner of A/B test 224). For example, the user may specify parameters of configuration 208 through a user interface provided by the A/B testing platform and/or a domain-specific language (DSL) associated with the A/B testing platform.

Parameters of configuration 208 may define criteria for targeting users with A/B test 224. For example, configuration 208 may specify one or more segments of users for inclusion in A/B test 224. Each segment may include attributes of the corresponding users, such as the users' locations, industries, companies, languages, and/or member identifiers. The attributes may also indicate the presence or absence of profile pictures, summaries, endorsements, and/or other fields in the users' profiles (e.g., with an online network and/or website). Within each segment, configuration 208 may specify a distribution of treatment assignments in A/B test 224 (e.g., 50% treatment and 50% control, 10% treatment and 90% control, 100% treatment, etc.).

Execution apparatus 206 uses configuration 208 to select users for inclusion in A/B test 224 and/or assign users in A/B test 224 for exposure to the treatment or control variants of A/B test 224. In turn, execution apparatus 206 may allow external code blocks 210 created by the owner of A/B test 224 to receive treatment assignments via an application-programming interface (API) associated with the A/B testing platform. For example, code blocks 210 may include conditional statements that call the API to retrieve treatment assignments for one or more users and select treatment or control variants for subsequent exposure to the users based on the treatment assignments.

When the owner of A/B test 224 decides to change the targeting criteria for A/B test 224, the owner may create a new configuration 208 and/or change the parameters of an existing configuration 208 for A/B test 224. The owner may also, or instead, utilize automatic ramping functionality of the A/B testing platform to automatically trigger changes in the targeting criteria and/or distribution of treatment assignments in A/B test 224.

For example, the owner may activate automatic ramping functionality for A/B test 224 within configuration 208 and/or another mechanism for setting up A/B test 224. Execution apparatus 206 may use targeting criteria from configuration 208 and/or generate targeting criteria based on the automatic ramping functionality to initially target users with A/B test 224 and/or divide the users between treatment and control groups in A/B test 224. Execution apparatus 206 may then collect a performance metric 228 related to the treatment and control versions of A/B test 224, calculate a risk of ramping up exposure to the treatment by a subsequent amount based on values of performance metric 228, and/or select the amount by which A/B test 224 is ramped up based on the risk and a risk tolerance associated with A/B test 224.

On the other hand, the owner may leave A/B test 224 running on the A/B testing platform long after A/B test 224 has been manually or automatically ramped to 100% exposure to treatment and/or A/B test 224 is no longer being used to compare the performance of the treatment and control variants. As a result, A/B test 224 may continue to consume processor, memory, and/or storage resources associated with the A/B testing platform without providing additional value or insight related to the performance of the treatment and control variants to the owner.

At the same time, A/B test 224 and/or other A/B tests may be used in systems or components that are external to the A/B testing platform. Such systems or components may include offline A/B tests that are execute on a periodic and/or batch-processing basis and/or A/B tests that use targeting functionality that is partially or fully implemented outside of the A/B testing platform. The A/B testing platform may thus be prevented from obtaining full usage information for the A/B tests and ascertaining whether or not the A/B tests are currently being used to collect and compare performance metrics.

To reduce unnecessary consumption of resources on the A/B testing platform, analysis apparatus 202 uses one or more criteria 222 to identify A/B test 224 and/or other A/B tests as candidates for removal from the A/B testing platform. Criteria 222 may include the ramp amount of each A/B test, the length of time the A/B test has been executing, and/or other factors.

For example, A/B test 224 may be flagged for removal from the A/B testing platform if A/B test 224 has been fully ramped to 100% for longer than a certain number of weeks or months. In another example, analysis apparatus 202 may identify A/B test 224 as a candidate for removal from the A/B testing platform if the owner of A/B 224 test has not viewed results of A/B test 224 and/or made changes to A/B test 224 for a pre-specified period. In a third example, A/B test 224 may be manually flagged for removal from the A/B testing platform by a user such as the owner of A/B test and/or an administrator of the A/B testing platform. As a result, the user may use the functionality of the system to trigger a “cleanup” of A/B test 224. In a fourth example, A/B test 224 may be identified as a candidate for removal from the A/B testing platform if A/B test 224 is being used by an external system or component and more than a certain number of weeks or months has passed since A/B test 224 was created.

Next, analysis apparatus 202 initiates a ramp-down 226 of A/B test 224 to assess the effect of a treatment variant in A/B test 224 on performance metric 228 for A/B test 224. For example, analysis apparatus 202 may perform ramp-down by very slightly decreasing exposure to the treatment variant (e.g., from 100% to 99.5%) and increasing exposure to the control variant by the same amount. Analysis apparatus 202 may also use the A/B testing platform's functionality to collect values of performance metric 228 after ramp-down 226 and compare the values with previous values of performance metric 228 before ramp-down 226 was initiated. As a result, analysis apparatus 202 may determine if performance metric 228 has a statistically significant change after ramp-down 226 is initiated. In other words, analysis apparatus 202 may use changes in performance metric 228 to detect if A/B test 224 is being used to exposed users to the treatment or control variants, even when analysis apparatus 202 does not have full usage information for A/B test 224 (e.g., because A/B test 224 is used by an external system or component).

Management apparatus 204 uses the result of the comparison performed by analysis apparatus 202 to safely terminate A/B test 224. If performance metric 228 does not significantly change after ramp-down 226 is initiated, A/B test 224 may no longer expose users to the treatment or control variants.

While performance metric 228 remains significantly unchanged, analysis apparatus 202 may continue monitoring performance metric 228 as ramp-down 226 progresses until ramp-down 226 is complete. For example, analysis apparatus 202 and/or another component of the system may perform ramp-down 226 by gradually decreasing user exposure to the treatment variant according to the following percentages: 100%, 99%, 95%, 75%, 50%, 25%, 0%. In another example, analysis apparatus 202 may use automatic ramping functionality of the A/B testing platform to select a series of amounts by which A/B test 224 is ramped down based on the risk associated with each amount and/or the risk tolerance of A/B test 224.

Once ramp-down 226 is complete (i.e., exposure to the treatment variant has reached 0%), management apparatus 204 may trigger termination 234 of A/B test 224. For example, management apparatus 204 may call an API associated with execution apparatus 206 to terminate A/B test 224. In turn, execution apparatus 206 may stop executing code that implements A/B test 224 and/or delete the code and/or configuration 208.

If performance metric 228 differs between the treatment and control groups after ramp-down 226 is initiated, analysis apparatus 202 may detect that A/B test 224 is being used to expose 100% of users to the treatment variant. As a result, continued ramp-down 226 may expose increasing numbers of users to the control variant, which may lead to a reduction in performance metric 228 and/or a negative impact on user experiences. Termination of A/B test 224 without discontinuing use of A/B test 224 by external code blocks 210 may further result in crashes, errors, and/or outages in a system that calls execution apparatus 206 for treatment assignments in A/B test 224.

As a result, management apparatus 204 may perform removal 232 of code blocks 210 prior to triggering termination 234 of A/B test 224. For example, management apparatus 204 may search a code base that implements functionality related to the treatment and control variants for a unique “test key” for A/B test 224. Next, management apparatus 204 may identify variables, conditional statements, and/or lines of code that directly or indirectly reference or use the test key in the code base and remove code blocks 210 containing the variables, conditional statements, and/or lines of code from the code base. After all external code blocks 210 that reference A/B test 224 are removed and/or disabled, management apparatus 204 may trigger termination 234 of A/B test 224.

The operation of management apparatus 204 may be illustrated with an example test key of “reputation.endorsement.change-first-endorser” for A/B test 224. The test key may be matched to the following variable declaration and initialization:
public static final String CHANGE_FIRST_ENDORSER=“reputation.endorsement.change-first-endorser”

The variable name of “CHANGE_FIRST_ENDORSER” in the above declaration may then be matched to a second variable declaration and initialization with the following form:
boolean applyFirstEndorser=“enable”.equals(testClient.getTreatment(endorserUrn, CHANGE_FIRST_ENDORSER));
   Because the “CHANGE_FIRST_ENDORSER” variable is always set to “enable” (i.e., a treatment assignment to a treatment group) once A/B test 224 is fully ramped, the “applyFirstEndorser” variable will evaluate to true in every instance.

Finally, the variable name of “applyFirstEndorser” in the second variable declaration may be used to identify the following conditional statement:

```
if (applyFirstEndorser) {
    return showFeatureA( );
} else {
    return showFeatureB( );
}
```

To enable safe termination 234 of A/B test 224, management apparatus 204 may remove both variable declarations and all parts of the conditional statement except for the “return showFeatureA( );” line. In turn, the remaining code may always expose users to the treatment variant without using A/B test 224.

By using A/B testing techniques to characterize experiments that are no longer used to collect performance metrics and/or make decisions related to the corresponding treatment and control variants, the system of FIG. 2 may allow for automatic safe removal of the experiments even when the experiments are used by external code blocks 210 to expose users to the treatment variants. In turn, the removed experiments may decrease computational and/or storage resources consumed by the experiments without adversely impacting the use of treatment variants that were tested using the experiments.

The removed experiments may further reduce and/or remove dependencies of applications that use the treatment variants on the A/B testing platform. In turn, the system may mitigate the adverse effects of outages and/or failures in the A/B testing platform on the execution of the applications. The functionality of the system may further be used to ramp down and/or remove dependencies of the applications on a given version of the A/B testing platform before the applications are upgraded to a newer version of the A/B testing platform. Consequently, the disclosed embodiments may improve the performance of computer systems and/or technologies for performing A/B testing and/or reclaiming computational and/or storage resources.

Those skilled in the art will appreciate that the system of FIG. 2 may be implemented in a variety of ways. First, analysis apparatus 202, management apparatus 204, execution apparatus 206, and/or data repository 134 may be provided by a single physical machine, multiple computer systems, one or more virtual machines, a grid, one or more databases, one or more filesystems, and/or a cloud computing system. Analysis apparatus 202, management apparatus 204, and execution apparatus 206 may additionally be implemented together and/or separately by one or more hardware and/or software components and/or layers.

Second, configuration 208, code blocks 210, performance metric 228, and/or other data used by the system may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness. In another example, code blocks 210 may be obtained from a code repository that is provided by and/or separate from data repository 134. In a third example, configuration 208 may be obtained from a configuration repository that is provided by and/or separate from data repository 134 and/or the code repository.

Third, the system may be adapted to various types of online controlled experiments and/or hypothesis tests. For example, the system of FIG. 2 may be used to automatically terminate unused A/B tests, studies, and/or other types of research designs for different features and/or versions of websites, social networks, applications, platforms, advertisements, recommendations, and/or other hardware or software components that impact user experiences.

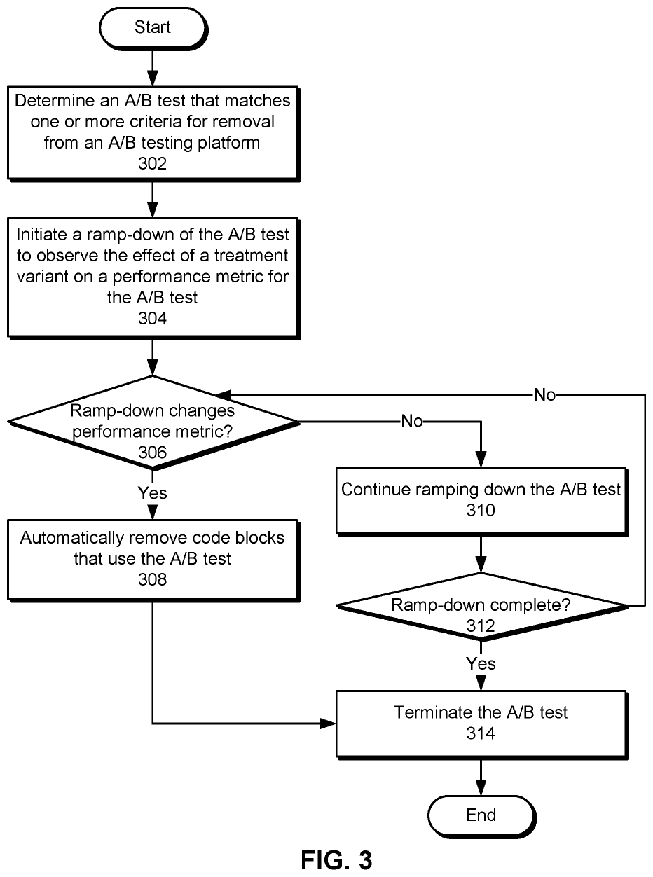

FIG. 3 shows a flowchart illustrating a process of using A/B testing to safely terminate an unused experiment in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, an A/B test that matches one or more criteria for removal from an A/B testing platform is determined (operation 302). For example, the A/B test may be flagged for removal from the A/B testing platform if the A/B test has been fully ramped to 100% exposure to treatment for a sustained period. An owner of the A/B test may optionally be notified that the A/B test has been identified as a candidate for removal from the A/B testing platform to allow the owner to respond before the A/B test is terminated. In another example, the owner and/or another user may manually identify the A/B test as a candidate for removal from the A/B testing platform.

Next, a ramp-down of the A/B test is initiated to observe the effect of a control variant on a performance metric for the A/B test (operation 304). For example, the A/B test may be ramped down from 100% exposure to the treatment variant to slightly less than 100% exposure to the treatment variant, resulting in a corresponding increase in exposure to the control variant. In turn, the A/B testing platform may be used to monitor the performance metric for statistically significant changes between the treatment and control groups of users in the A/B test.

Termination of the A/B test may be managed based on changes in the performance metric that are caused by the ramp-down (operation 306). If the ramp-down causes a significant change in the performance metric between the treatment and control groups, code blocks that use the A/B test are automatically removed (operation 308). The code blocks may include variables, conditional statements, and/or other lines of code that use treatment assignments and/or other attributes used to execute the A/B test by the A/B testing platform.

After the code blocks are removed and/or disabled, the A/B test is terminated (operation 314). For example, execution of the A/B test may be discontinued on the A/B testing platform, and a configuration for the A/B test may be deleted. Consequently, termination of the A/B test may reduce the computational load and/or storage overhead associated with the A/B testing platform.

If the ramp-down does not cause a significant change in the performance metric between the treatment and control groups, the ramp-down is continued (operation 310) while changes to the performance metric are monitored (operation 306) until the ramp-down is complete (operation 312). After the A/B test has been fully ramped down to 0% exposure to the treatment variant, the A/B test is terminated (operation 314). Conversely, if the performance metric substantially changes between the treatment and control groups during the ramp-down, code blocks that use the A/B test may be removed (operation 308) before the ramp-down proceeds and/or the A/B test is terminated.

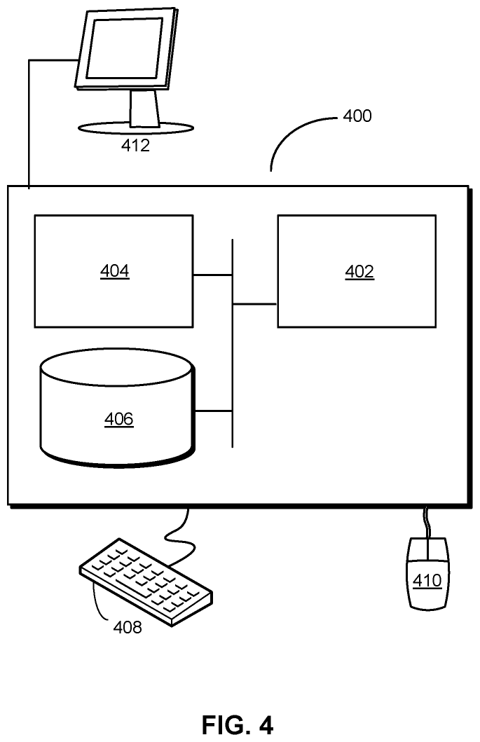

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for using A/B testing to safely disable unused experiments. The system includes an analysis apparatus and a management apparatus, one or more of which may alternatively be termed or implemented as a module, mechanism, or other type of system component. The analysis apparatus determines a first A/B test that matches one or more criteria for removal from an A/B testing platform. Next, the analysis apparatus initiates a first ramp-down of the first A/B test to observe an effect of a control variant on a performance metric for the first A/B test. When the effect includes a change in the performance metric, the management apparatus automatically removes code blocks that use the first A/B test on the A/B testing platform and terminates the first A/B test. When the ramp-down of a second A/B test does not change the performance metric of a second/B test, the analysis apparatus verifies a lack of change in the performance metric while the ramp-down continues, and the management apparatus terminates the second A/B test when the ramp-down is complete.

In addition, one or more components of computer system 400 may be remotely located and connected to the other components over a network. Portions of the present embodiments (e.g., analysis apparatus, management apparatus, execution apparatus, data repository, A/B testing platform, online network, etc.) may also be located on different nodes of a distributed system that implements the embodiments. For example, the present embodiments may be implemented using a cloud computing system that uses A/B testing to identify and terminate unused remote experiments.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, by one or more computer systems, a first A/B test that matches one or more criteria for removal from an A/B testing platform;
initiating, by the one or more computer systems, a first ramp-down of the first A/B test to observe an effect of a control variant on a performance metric for the first A/B test; and
when the effect comprises a change in the performance metric:
automatically removing code blocks that use the first A/B test on the A/B testing platform; and
terminating the first A/B test.

2. The method of claim 1, further comprising:
initiating a second ramp-down of a second A/B test; and
when the second ramp-down does not produce a change in another performance metric for the second A/B test, continuing the second ramp-down of the second A/B test.

3. The method of claim 2, further comprising:
continuing to verify a lack of change in the other performance metric during the second ramp-down; and
terminating the second A/B test when the second ramp-down is complete.

4. The method of claim 1, further comprising:
transmitting, to an owner of the first A/B test, a notification identifying the first A/B test as a candidate for removal from the A/B testing platform.

5. The method of claim 1, wherein terminating the first A/B test comprises:
discontinuing execution of the first A/B test on the A/B testing platform; and
deleting a configuration for the first A/B test.

6. The method of claim 1, wherein the code blocks comprise a conditional statement for evaluating a treatment assignment in the first A/B test.

7. The method of claim 6, wherein the code blocks further comprise a code block for selecting the control variant based on the treatment assignment.

8. The method of claim 1, wherein the one or more criteria comprise a user selection of the first A/B test for removal from the A/B testing platform.

9. The method of claim 1, wherein the one or more criteria comprise a complete ramp-up of the first A/B test.

10. The method of claim 9, wherein the one or more criteria further comprise a sustained period since the complete ramp-up of the first A/B test.

11. A system, comprising:
one or more processors; and
memory storing instructions that, when executed by the one or more processors, cause the system to:
determine a first A/B test that matches one or more criteria for removal from an A/B testing platform;
initiate a first ramp-down of the first A/B test to observe an effect of a control variant on a performance metric for the first A/B test; and
when the effect comprises a change in the performance metric:
automatically remove code blocks that use the first A/B test on the A/B testing platform; and
terminate the first A/B test.

12. The system of claim 11, wherein the memory further stores instructions that, when executed by the one or more processors, cause the system to:
initiate a second ramp-down of a second A/B test; and
when the second ramp-down does not produce a change in another performance metric for the second A/B test, continue the second ramp-down of the second A/B test.

13. The system of claim 12, wherein the memory further stores instructions that, when executed by the one or more processors, cause the system to:
continue to verify a lack of change in the other performance metric during the second ramp-down; and
terminate the second A/B test when the second ramp-down is complete.

14. The system of claim 11, wherein the memory further stores instructions that, when executed by the one or more processors, cause the system to:
transmit, to an owner of the first A/B test, a notification identifying the first A/B test as a candidate for removal from the A/B testing platform.

15. The system of claim 11, wherein terminating the first A/B test comprises:
discontinuing execution of the first A/B test on the A/B testing platform; and
deleting a configuration for the first A/B test.

16. The system of claim 11, wherein the code blocks comprise at least one of:
a conditional statement for evaluating a treatment assignment in the first A/B test; and
a code block for selecting the control variant based on the treatment assignment.

17. The system of claim 11, wherein the one or more criteria comprise a user selection of the first A/B test for removal from the A/B testing platform.

18. The system of claim 11, wherein the one or more criteria comprise a complete ramp-up of the first A/B test for a sustained period.

19. A non-transitory computer-readable storage medium storing instructions that when executed by a computer cause the computer to perform a method, the method comprising:
determining a first A/B test that matches one or more criteria for removal from an A/B testing platform;
initiating a first ramp-down of the first A/B test to observe an effect of a control variant on a performance metric for the first A/B test; and
when the effect comprises a change in the performance metric:
automatically removing code blocks that use the first A/B test on the A/B testing platform; and
terminating the first A/B test.

20. The non-transitory computer-readable storage medium of claim 19, wherein the method further comprises:
initiating a second ramp-down of a second A/B test; and
when the second ramp-down does not produce a change in another performance metric for the second A/B test, continuing the second ramp-down of the second A/B test;
continuing to verify a lack of change in the other performance metric during the second ramp-down; and
terminating the second A/B test when the second ramp-down is complete.
